(19) United States
(12) Patent Application Publication
(10) Pub. No.: US 2003/0206519 A1
(43) Pub. Date: Nov. 6, 2003

(54) System and method for encoding and decoding messages

(76) Inventors: Michael Sanders, The Sea Ranch, CA (US); William H. Papazian, Stamford, CT (US)

Correspondence Address: Patrick J. Fay, Fay Kaplun & Marcin, LLP, Suite 702, 150 Broadway, 7th Floor, New York, NY, 10038, US

(21) Appl. No.: 10/139,034

(22) Filed: May 3, 2002

(51) Int. Cl. H04J 1/16; H04L 12/66

(52) U.S. Cl. 370/230; 370/352

(57) ABSTRACT

A system, comprising a first module receiving data in a first format and a library module building a structure in a buffer containing a plurality of data elements in the first format and creating entries corresponding to each of the plurality of data elements, each entry including a first pointer to the corresponding data element in the structure, wherein, when the first module requests a first one of the plurality of data elements, the library module reformats the first one of the data elements into a second format, stores the reformatted first one of the data elements and creates a second pointer from the corresponding entry to the reformatted first one of the data elements, the first module retrieving the reformatted first one of the data elements using the second pointer from the corresponding entry.

### BACKGROUND INFORMATION

The public switched telephone network (“PSTN”) is the world's collection of interconnected voice-oriented public telephone networks. The PSTN is an aggregation of circuit switching telephone networks which route phone calls between consumers. Today, the PSTN is almost entirely digital technology, but some analog remnants remain (e.g., the final link from a central office to the user). The transmission and routing of calls via the PSTN is governed by a set of standards so that various providers of telephone service may easily route calls between their customers. Thus, a first consumer having telephone service A is able to call a second consumer having telephone service B, and the routing of such a call may go through networks owned by various other telephone services C-E. The result being the appearance of a seamless transmission between the first and second consumers.

As an alternative to using standard telephones on the PSTN, consumers may also use their personal computers (“PCs”) to make phone calls to other PC users. The transmission of a call via a PC is generally referred to as Voice over Internet Protocol (“VoIP”) technology. VoIP is a set of facilities for managing the delivery of voice information using the Internet Protocol. These PC to PC phone calls are transmitted via the Internet. However, in some instances, a consumer on a standard telephone desires to call a consumer using a PC phone, or vice versa. Thus, standards have been developed to effectively route these types of phone calls.

### SUMMARY OF THE INVENTION

A system, comprising a first module receiving data in a first format and a library module building a structure in a buffer containing a plurality of data elements in the first format and creating entries corresponding to each of the plurality of data elements, each entry including a first pointer to the corresponding data element in the structure, wherein, when the first module requests a first one of the plurality of data elements, the library module reformats the first one of the data elements into a second format, stores the reformatted first one of the data elements and creates a second pointer from the corresponding entry to the reformatted first one of the data elements, the first module retrieving the reformatted first one of the data elements using the second pointer from the corresponding entry.

A method, comprising the steps of receiving data in a first format, building a structure from the data in a buffer containing a plurality of data elements in a first format, creating entries corresponding to each of the data elements in the buffer, each entry including a first pointer to the corresponding data element in the structure, reformatting a first one of the data elements from the first format into a second format, storing the reformatted first one of the data elements in the buffer, and adding a second pointer from the corresponding entry to the reformatted first one of the data elements.

Furthermore, a library module, comprising a first element configured to build a structure containing a plurality of data elements in a first format and selectively reformatting the data elements into a second format based on a request from network modules and a buffer storing the data elements in the first format and the second format, the buffer further including entries corresponding to each of the data elements, a first pointer from each entry to the corresponding data element in the first format and a second pointer from each entry to the corresponding data element in the second format.

### BRIEF DESCRIPTION OF DRAWINGS

FIG. 1 shows an exemplary network arrangement for the connection of voice communications;

FIG. 2 shows an exemplary block diagram of modules to implement the SS7 protocol on a hardware component according to the present invention;

FIG. 3 shows an exemplary TCAP message having an exemplary information element according to the present invention;

FIG. 4 shows an exemplary tag having a class, a form and a tag code according to the present invention;

FIG. 5 shows an exemplary implementation of a GIE library according to the present invention;

FIG. 6 shows an exemplary method of decoding a message according to the present invention;

FIG. 7 shows an exemplary GIE buffer having a series of IE listings and the corresponding PDU data and IE data structures according to the present invention;

FIG. 8 shows an exemplary text message being converted into a data structure according to the present invention;

FIG. 9 shows details of an exemplary data structure decoded from a text message according to the present invention.

### DETAILED DESCRIPTION

The present invention may be further understood with reference to the following description of preferred exemplary embodiments and the related appended drawings, wherein like elements are provided with the same reference numerals. The exemplary embodiments described herein refer to voice communications (e.g., phone calls). However, those of skill in the art will understand that the present invention may be equally applied to systems, networks and/or hardware used for communication of data or other information. In this description of exemplary embodiments of the present invention, the terms switching and routing as applied to communications will be used interchangeably. Those of skill in the art will understand that in the context of voice and/or data communications a switch and a router generally perform different functions. However, in the context of the present invention, it is only important to understand that switches, routers and any other hardware equipment may be used to direct the communication through a network so that the communication is transmitted to the desired end location. Those of skill in the art also understand the basic concepts of the transmission of voice and/or data information across network devices. Those who desire a more detailed discussion of network data transfer may consult a reference such as, Perlman, Radia “Interconnections Second Edition—Bridges, Routers, Switches, and Internetworking Protocols,” Addison Wesley, 2000.

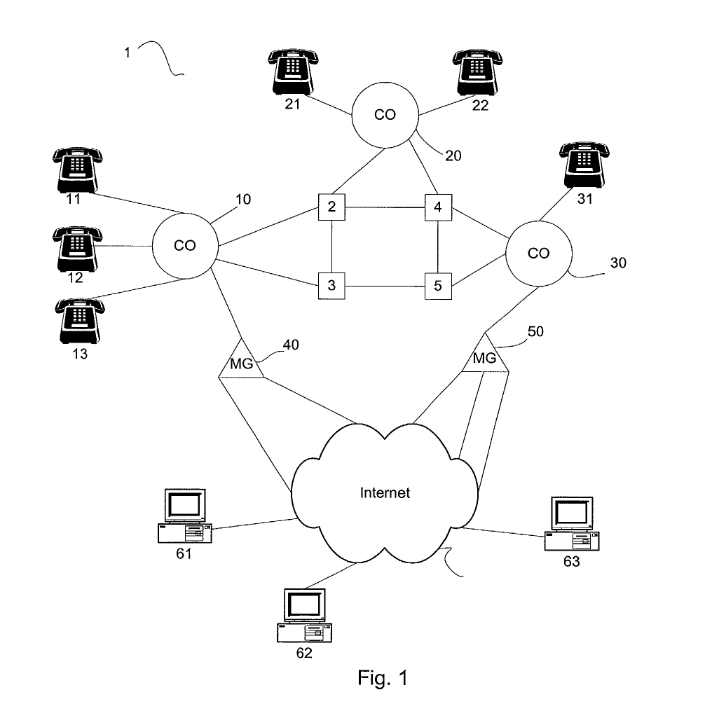

FIG. 1 shows an exemplary network arrangement 1 for the connection of voice communications. The network arrangement 1 includes three central offices (“CO”) 10-30 which are locations where telephone companies terminate customer lines and locate switching equipment to interconnect those lines with other networks. In this example, the customer lines 11-13 terminate at the CO 10, the customer lines 21-22 terminate at the CO 20 and the customer line 31 terminates at the CO 30. The customer lines may be any type of lines, for example, plain old telephone service (“POTS”) lines, integrated services digital network (“ISDN”) lines, frame relay (“FR”) lines, etc. In this example, each of the customer lines (e.g., customer line 11) may be considered a POTS line attached to a standard telephone at the customer location.

Between the COs 10-30, there may be a series of switching stations 2-5. These switching stations 2-5 direct the calls along a route from a transmitting CO to a receiving CO. For example, a user on the customer line 11 may attempt to call a user at the customer line 31. The call will be transmitted from the customer line 11 to the CO 10, which will then route the call into the system to arrive at the CO 30. When the call is in the system, it may take a variety of routes between the CO 10 and the CO 30 based on various parameters, e.g., system traffic, shortest route, unavailable switches, etc. In this example, the call may be routed from the CO 10 to the switching station 2, through to the switching station 4 and then to the CO 30 which connects the call to the customer line 31. The portion of the network arrangement 1 described above may be considered the PSTN portion of exemplary network arrangement 1.

In addition, there may be a VoIP portion of network arrangement 1. In this example, personal computers (“PC”) 61-63 are equipped with hardware and software allowing users to make voice phone calls. The PCs 61-63 have connections to the Internet 60 for the transmission of the voice data for the phone calls made by the users. If a PC user makes a voice call to another PC user (e.g., user of PC 61 calls user of PC 62), the call maybe routed from the PC 61 through the Internet 60 to the PC 62. However, for calls from the PSTN portion of the network arrangement 1 to the VoIP portion, media gateways (“MG”) 40-50 act as a router for such calls. Thus, if the user of PC 61 calls the user of customer line 31, the call may be routed from the PC 61 through the Internet 60 to the MG 50 and through to the CO 30 which connects the call to the customer line 31. Those of skill in the art will understand that the previously described components are only exemplary and that there may be other components used to route calls, for example, the VoIP portion of the network may contain a media gateway controller.

As seen from the above described examples, the phone calls are routed through the exemplary network arrangement 1 by a variety of hardware devices (e.g., COs, switching stations, MGs, etc.). Standards groups have been set up to promulgate standards for the protocols to route these phone calls through the various telephone systems. For example, Signaling System 7 (“SS7”) is a telecommunications protocol defined by the International Telecommunications Union (“ITU”). For a more detailed discussion of SS7 see the following standard publication, “ANSI, T1.110-1992, Signaling System 7 (SS7) General Information, 1992” and the sequence of standards, ANSI, T1.111-114, related to SS7. In general, the SS7 protocol is implemented on the PSTN portion equipment (e.g., CO 10-30, switching stations 2-5) and may be used for a variety of features related to phone calls, for example, basic call setup, management, tear down, local number portability, toll-free and toll wireline services, call forwarding, three-way calling, etc.

Another example of a protocol standard for the VoIP portion of network arrangement 1 is the MEGACO standard by the Internet Engineering Task Force (“IETF”). For a more detailed discussion of the MEGACO standard see the following publication, “IETF, RFC 3015, Megaco Protocol Version 1.0.” MEGACO defines the protocols used between elements of a physically decomposed multimedia gateway consisting of a MG (e.g., MGs 40-50) and a Media Gateway Controller. Those of skill in the art will understand that the above described protocols are only exemplary and there are additional implemented protocols and new protocols that may be implemented in the future and the present invention is equally applicable to any of these systems implementing protocols.

Thus, each of the described components is network arrangement 1 may implement a variety of protocols to route calls to the desired location. The described components may include a processor or other computing device to provide the desired functionality (e.g., routing of the phone calls, etc.). Thus, these components may contain software components to instruct the processor (or other computing device) to perform the desired functions and implement the various protocols. The present invention may be implemented on any of the above described components or any other processor based components used in the transfer of information through a network.

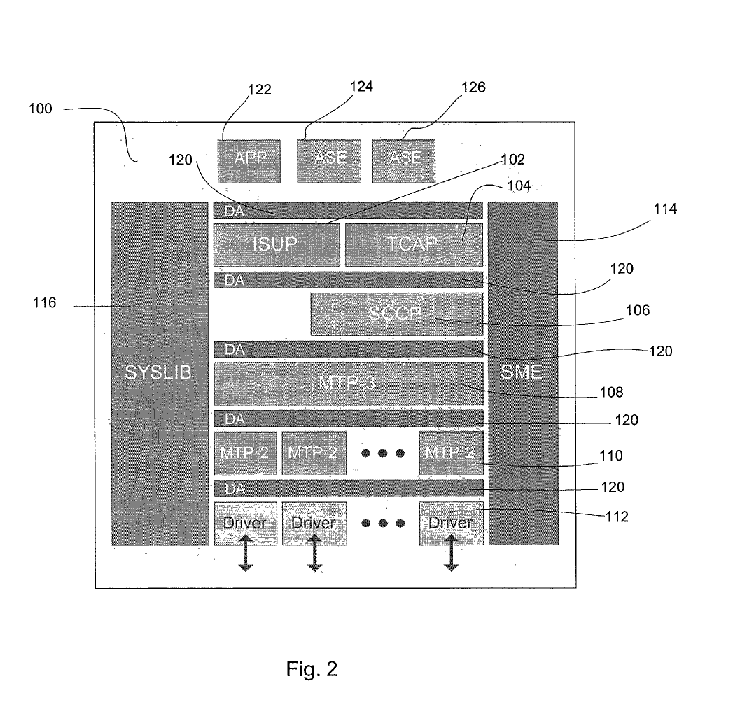

FIG. 2 shows an exemplary block diagram of a system 100 of modules to implement the SS7 protocol on a hardware component. For example, switching station 2 may implement the modules described in FIG. 2 in order to provide the functionality related to the SS7 protocol (e.g., 800 number look-up, etc.). An exemplary embodiment of the present invention will be described in reference to the exemplary block diagram 100 for implementing the SS7 protocol. However, those of skill in the art will understand that the present invention may be implemented on a variety of hardware devices that implement any protocol and is not limited to the modules described in this exemplary embodiment. A brief description of the SS7 modules and their functions will be given. However, the present invention is not dependent on the SS7 protocol or any protocol.

The drivers 112 provide the interface between the software and the physical hardware device. The drivers 112 may be considered the lowest level layer in the protocol. Generally, the drivers 112 provide services such as the initialization of hardware and hardware support tasks, hardware management and data packet transfer. However, the specific tasks accomplished by the drivers 112 are highly dependent on the underlying hardware device. For example, in the case of switches, the drivers 112 may be responsible for switch and port statistic retrieval and management.

The Message Transfer Part, Level 2 (“MTP-2”) modules 110 provide link-layer functionality such as error checking, flow control and sequence checking so that two endpoints of the signaling link can reliably exchange signaling messages. The Message Transfer Part, Level 3 (“MTP-3”) module 108 provides network layer functionality, for example, node addressing, routing, alternate routing and congestion control to ensure that messages can be delivered between signaling points across the SS7 network.

The Signaling Connection Control Part (“SCCP”) module 106 provides transport layer functionality to address an application within a signaling point. Examples include 800 calls and calling card calls. The Integrated Services Digital Network User Part (“ISUP”) module 102 also provides [transport layer??] functionality to define the messages and protocol used for the establishment and tear down of both ISDN and non-ISDN voice and data calls. The ISUP module 102 provides support for features such as, enbloc and overlap sending, link-by-link signaling using a pass-along method, end-to-end signaling using SCCP method, local number portability, message segmentation, etc. The Transaction Capabilities Application Part (“TCAP”) module 104 provides session layer functionality to define the messages and protocol used to communicate between applications in signaling nodes. The TCAP module 104 may be used for database services such as calling card, 800 calls and repeat dialing.

The System Management Entity (“SME”) module 114 provides three main functions. First, the initialization, configuration, and control for the different modules and the entire system 100. Second, a database of configuration and management information. Third, system logging, tracing and statistical functions. The SME module 114 provides an alternate data path for the configuration data from each of the different layers. Thus, each layer does not need to know the configuration data from the other layers. For example, in the context of the protocol, the MTP-3 module 108 does not need to pass its configuration data to any of the other layers, e.g., MTP-2 module 110, SCCP module 106, etc.

The System Library module 116 provides an abstraction between the protocol software and the actual operating system of the hardware device. This eliminates the need to depend on the system interface defined for a particular operating system and allows the exemplary SS7 modules to be ported between various operating systems and kernels without any modification. The functionality provided by the System Library module 116 may include, for example, buffer manipulation, interrupt locking, memory manipulation, signaling/semaphore, message logging, timers, vector management, etc.

As shown in FIG. 2, a delivery agent 120 is interposed between each of the various layers of modules. For example, there is a delivery agent 120 situated between the MTP-3 module 108 and the MTP-2 module 110. The delivery agent 120 provides a portable mechanism that the modules may use to exchange information. The delivery agent 120 is a common method of interface between each of the modules. The delivery agent 120 allows a user of the system 100 to enter the system at any level because the interface for the modules is common at every level. It may also allow a user to decompose the system. A more detailed description of the delivery agent 120 is provided in the U.S. patent application entitled “System and Method for Creating a Communication Connection” to the named inventors Michael Sanders and Brad Nelson, filed on Apr. 30, 2002, assigned to the Assignee of the present application. As such, the above-identified application is expressly incorporated herein, in its entirety, by reference.

The system 100 may also include an application module 122 and application service elements (“ASE”) 124 and 126. These application layer modules 122-126 may provide specific applications which a user may desire on the particular hardware component on which the system 100 is implemented. The application layer modules 122-126 may be provided as an integral part of system 100 or may be provided by third party vendors based on the particular application.

Each of the modules within system 100 may exchange messages with other modules that are either in a higher level or lower level layer. For example, the SCCP module 106 may exchange messages with the ISUP module 102 and the TCAP module 104, i.e., higher level layer modules, or with the MTP-3 module 108, i.e., a lower level layer module. The messages that are passed from a module may be formatted in various manners. Some of these message formats may be set by standards and/or standard committees. In the following example, a message format for TCAP module 104 messages will be described. This format is described in detail in ITU-T Q.773 Specifications of Signaling System No. 7—Transaction Capabilities Application Part, 06/97 (“ITU-T Q.773”). Those of skill in the art will understand that the use of a TCAP message to describe the present invention is only exemplary. The present invention may be implemented for any message format. For example, the message format described in ITU-T Q.931 ISDN User Network Interface Layer 3 Specification for Basic Call Control, 05/98.

A TCAP message is structured as a single constructor information element. The TCAP message may include a transaction portion containing information elements used by a transaction sublayer, a component portion containing information elements used by a component sublayer, and a dialog portion containing the application context and user information. Each component is a constructor information element.

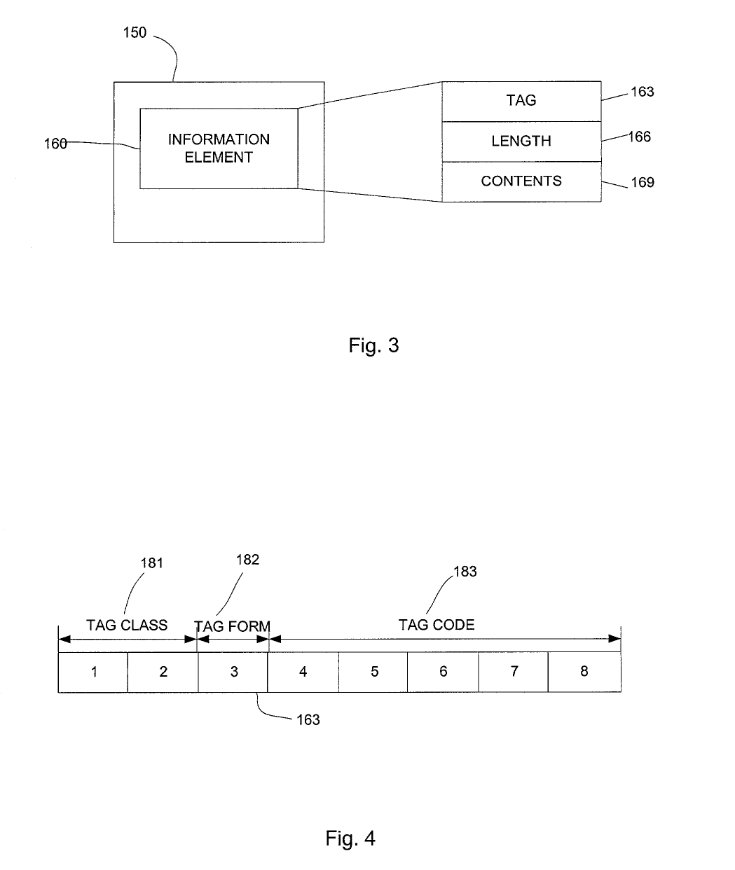

FIG. 3 shows an exemplary TCAP message 150 having an exemplary information element 160. The information element 160 has a structure which may include three fields, a tag field 163, a length field 166 and a content field 169. Each field 163-169 may be coded using one or more octets which contain 8 bits. The tag field 163 distinguishes one information element from another and governs the interpretation of the content field 169. FIG. 4 shows an exemplary tag field 163 which may include a tag class 181, a tag form 182 and a tag code 183. The exemplary tag field 163 shown in FIG. 4 is one octet in length, but the tag field 163 may include additional octets. The tag class 181 generally occupies the two most significant bits of the tag field 163 and are coded to indicate a specific class of the tag. The classes may include a universal class, an application-wide class, a context specific class and a private use class. Those who are interested in the specific uses of each tag class 181 may refer to ITU-T Q.773.

The tag form 182 may be a single bit that is used to indicate whether the information element 160 is a primitive or a constructor. A primitive information element is one that has a single value, i.e., the content field 169 of the information element 160 contains the information the information element 160 is intended to convey. A constructor information element is one that includes one or more information elements, i.e., the content field 169 of the information element 160 is one or more additional information elements. A constructor information element nests additional information elements, which, in turn, may nest additional information elements. The tag code 183 distinguish one element type from another of the same tag class 181. Additional extension octets may be added to the tag field 163 in order to distinguish additional elements based on the number of bits in the tag code 183.

Referring back to FIG. 3, the length field 166 may be coded to indicate the number of octets in the content field 169. The length of the contents may be coded using standard forms, e.g., short, long, indefinite. For example, using the short form, the most significant bit of the length field 166 octet may be coded to indicate the short form is being used and the remaining seven bits may indicate any length for the content field 169 up to 127 octets. If the length of the content field 169 is greater than 127 octets, the long form may be used where the most significant bit of the length field 166 may be coded to indicate the long form is being used. The remaining seven bits of the first octet encode a number one less than the size of the length field 166 in octets as an unsigned binary number. The length of the content field 169 is then encoded as an unsigned binary number in any additional octets that are needed to represent the length of the content field 169. The indefinite form may be one octet and may be used when the information element 160 is a constructor. The indefinite form has a specific value that indicates that a special end-of-contents indicator will terminate the content field 169.

The content field 169 is the substance of the information element 160 and contains the information the element is intended to convey. As described above, the content field 169 may contain primitive information, i.e., a single value content, or constructor information, i.e., additional information elements. The length of the content field 169 is variable depending on the information to be conveyed. The content field 169 may be interpreted in a type-dependent manner, i.e., in accordance with the tag field 163 value.

As can be seen from the above description, the TCAP messages are bit formatted information. However, this may not be the easiest format to access the information contained in the information elements 160. The developers and users of application layer modules (e.g., application 122 and ASEs 124 and 126) and the TCAP module 104 itself, may desire to access the information contained in the information elements in a different format, e.g., as a C structure. Thus, one exemplary embodiment of the present invention provides a generic information element (“GIE”) library to pack and unpack information elements into more accessible structures.

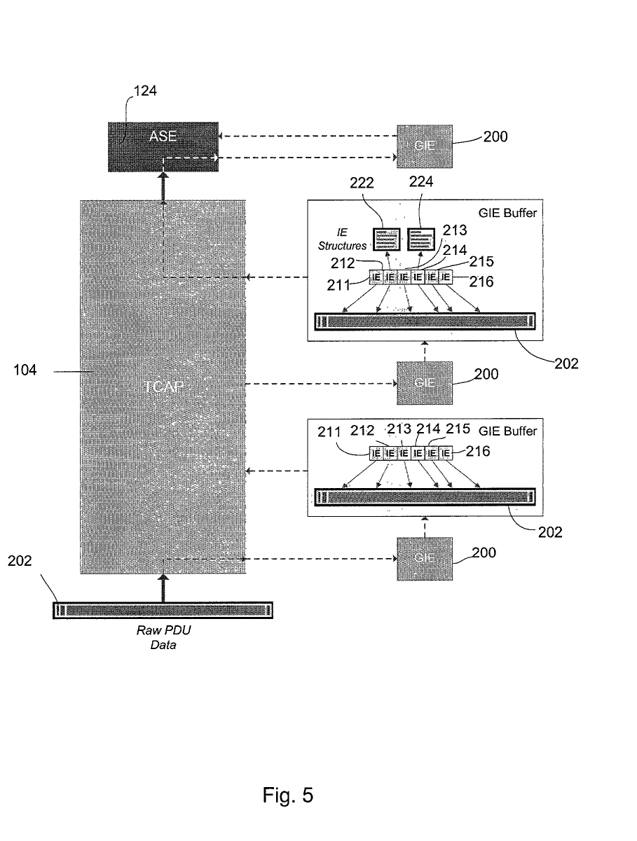

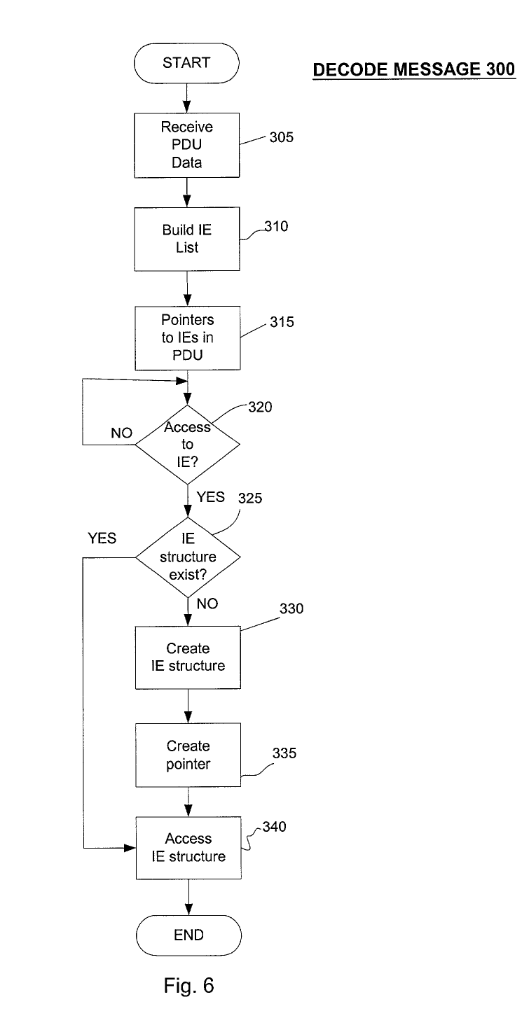

FIG. 5 shows an exemplary implementation of a GIE library 200 according to the present invention. The operation of the GIE library 200 will be described with reference to FIG. 5 and FIG. 6 which shows an exemplary method 300 of decoding a message. In this example, the message is a TCAP message containing a series of information elements as described above. In step 305, the TCAP module 104 receives the protocol data unit (“PDU”) data 202 which contains raw data in, for example, the TCAP message format described above.

In the next step 310, the TCAP module 104 calls the GIE library 200 to build a structure containing an inventory of the information elements present in the PDU data 202. For example, the GIE library 200 may parse the PDU data 202 to determine the various information elements included in the PDU data 202. As described above with reference to FIGS. 3-4, the information element 160 has a predefined structure which the GIE library 200 may parse. In addition, the predefined structure allows each of the information elements 160 to be uniquely identified. In completing this step, the GIE library 200 creates the GIE buffer 205 with a listing of the information elements. In this example, the GIE buffer 205 contains a list with entries for information elements 211-216.

In step 315, the GIE library 200 also provides pointers from the GIE buffer 205 listing to the information elements contained in the PDU data 202. As shown in FIG. 5, each of the listings for the information elements 211-216 have a pointer to the corresponding information element in the PDU data 202. In step 320, the TCAP module 104 determines whether it requires access to the information contained in the information elements included in the PDU data 202. If the TCAP module 104 does not require such access, the process continues to loop until the TCAP module 104 encounters an information element from which the information is required. Those of skill in the art will understand that the PDU data 202 may contain a series of information elements, of which, the TCAP module 104 only needs access to a subset of the series of information elements. For example, as shown in FIG. 5, the PDU data 202 may contain six information elements corresponding to the entries 211-216. However, the TCAP module 104 may not require access to all six of these information elements, but only a subset of the six.

If the TCAP module 104 needs access to the information in any of the information elements (e.g., information elements 211-216), the process continues to step 325, where the TCAP module 104 determines whether the information element has been converted into the required data structure (e.g., C structure). For example, the IE data structure may already exist because the TCAP module 104 may have previously accessed this information element. The TCAP module 104 may make this determination through a communication (e.g., a function call) to the GIE library 200 which determines whether there is a pointer from the information element listing in the GIE buffer 205 to an information element (“IE”) data structure. If no such structure exists, the process continues to step 330 where the GIE library 200 creates an IE data structure using the information contained in the information element. As described above, the GIE library 200 may parse the PDU data 202 and may also parse each individual information element because the information element has a definite structure (e.g., the TCAP information element described above). Those of skill in the art will understand that the parsed information from the information element maybe transformed into any IE data structure (e.g., C structure, text structure, XML structure, etc.) using known programming techniques. The IE data structure may then be stored in the GIE buffer 205 and, in step 335, a pointer may be created from the listing in the GIE buffer 205 to the IE data structure.

For example, in FIG. 5, if the TCAP module 104 desires the information contained in the information element 212 in a particular form of IE data structure, the TCAP module 104, through a call to the GIE library 200, may indicate the desire for this information element 212. The GIE library 200 may then extract the information from the actual information element 212 and create an IE data structure 222 corresponding to the information element 212 and store this IE data structure 212 in the GIE buffer 205 (step 330). The GIE library 200 may then create a pointer from the listing for the information element 212 to the newly created IE data structure 212 corresponding to the information element 212 (step 335). Continuing with the process, if the IE data structure exists (step 325) or after the new IE data structure is created with a pointer (steps 330-335), the TCAP module 104 may then access the information contained in the information element via the IE data structure (step 340). As can be seen from this example, if the TCAP module 104 does not need access to the information in any information element, the corresponding IE data structure does not need to be created at this time. This saves both processing time and memory in the GIE buffer 205.

As described above, other modules (e.g., ASE module 124) may also require access to the information contained in the information elements 211-216 of the PDU data 202. These modules may also desire this access to be in the format of the IE data structures. Thus, these modules may use the same process 300 to gain access to this information. The following example will use the ASE module 124 as an example of a module which may desire to access the IE data structures for the information elements. The steps 305-315 are previously carried out by the TCAP module 104 and the GIE library 200 resulting in the structure and the entries with the pointers from the entries to the information elements in the PDU data 202.

The ASE module 124 may proceed directly to step 320 to determine if it needs access to any of the information elements. If the ASE module 124 requires access, it may proceed to step 325 to determine if the particular IE data structure exists. As described above, the TCAP module 104 may have previously required the information element and the GIE library 200 may have converted the information element into an IE data structure. In this case, the ASE module 124 may proceed directly to step 340 and access the IE data structure in the GIE buffer 205 via the pointer from the information element listing to the IE data structure.

If the particular IE data structure does not exist (e.g., the TCAP module 104 did not need access to the information element), the process continues to step 330 where the GIE library 200 creates the IE data structure form the information contained in the information element from the PDU data 202. The GIE library 200 may then create a pointer from the listing for the information element to the newly created IE data structure corresponding to the information element 212 (step 335). The ASE module 124 may then access the information contained in the information element via the IE data structure (step 340). If there are no modules which need access to the information in any information element, the corresponding IE data structure does not need to be created. The process of converting the information elements into IE data structures is only carried out when a specific module makes a request for the information. This saves both processing time and memory in the GIE buffer 205.

A similar process may be used in the reverse to encode messages from the ASE 124 to the TCAP module 104. For example, the ASE 124 may desire to pass messages to the network which requires the information in the PDU data 202 format (e.g. via information elements). The ASE 124 may have the information in a series of IE data structures. If the corresponding information element does not exist, the GIE library 200 creates the information element from the IE data structure and it is then sent into the network.

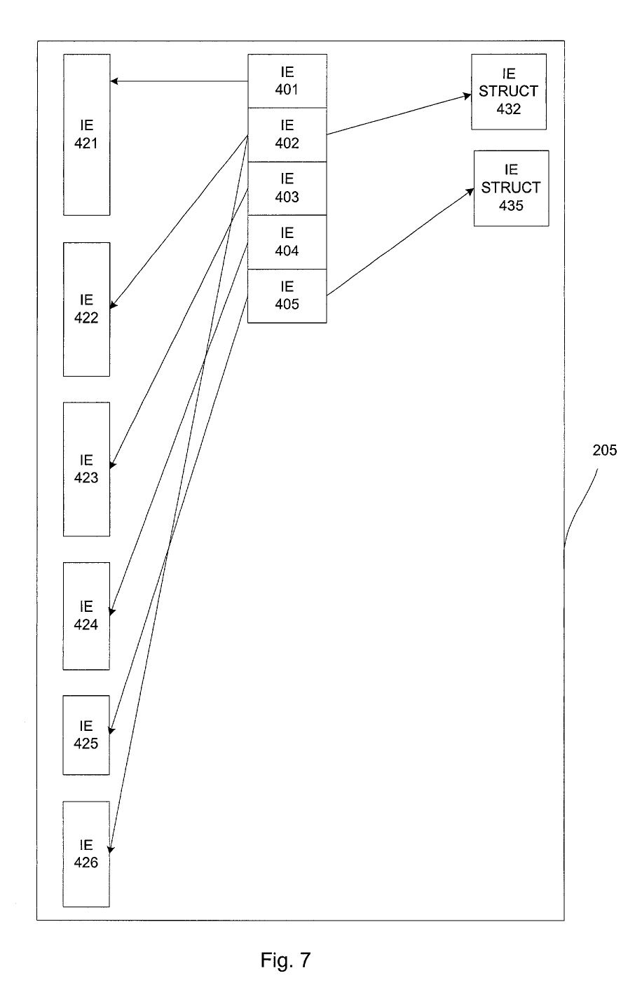

FIG. 7 shows an exemplary GIE buffer 205 that has a series of IE listings 401-405 and the corresponding information elements data 421-426 and IE data structures 432-435. Those of skill in the art will understand that the exemplary GIE buffer 205 may be populated using the method described with reference to FIG. 6. The current state of the GIE buffer 205 may change as additional information elements may be converted into IE data structures. As described above, the information elements 421-426 may be received in the format of PDU data and the GIE library 200 may determine each of the information elements 421-426 that are contained in the PDU data. The GIE library 200 may then add a listing to the GIE buffer 205 for each unique information element. In this example, the GIE library 200 has determined there are five unique information elements contained in the PDU data. Thus, there are five information elements 401-405 listed in the GIE buffer 205. In this example, the listing for information element 402 is common for both information elements 422 and 426 meaning that two information elements appear more than once in the PDU data. It is not necessary to list the same information element 422 and 426 twice. The listing may just include two pointers to both the information element 422 and 426.

As described above, an IE data structure is only created when it is needed and, once created, it is not duplicated. In this example, the current state of the system has only needed two of the information elements 401-405 converted into the IE data structures 432 and 435. For example, information element 421 has not been converted into an IE data structure because there is no module (e.g., TCAP module 104, ISUP module 102, ASE module 124, etc.) that has requested the information contained in the information element 421. If a module desires the information from information element 421, the GIE library 200 may then create the corresponding IE data structure. In contrast, information element 425 has been converted into an IE data structure 435 with a pointer from the information element listing 405 to the IE data structure 435. Therefore, any module may call the GIE library to access this information element 425 and, via the pointer from the information element listing 405, receive the IE data structure 435 corresponding to the information element 425.

Those of skill in the art will understand that the above description correlated each of the PDU data with a GIE buffer 205 on a one-to-one basis. Thus, each of the PDU data had a dedicated GIE buffer 205 which may be in the form of a particular memory address in, for example, random access memory (“RAM”), hard drive, etc. As each of the PDU data is processed, the GIE buffer 205 may be purged to allow for additional PDU data to be processed. The GIE library 200 may create the GIE buffer 205 upon receipt of the initial PDU data or the GIE buffer 205 may be persistent. In an alternative exemplary embodiment, it may also be possible to continue to expand a single GIE buffer 205 as more PDU data is processed by the GIE library 200. For example, a first PDU data 202 may contain six information elements and the next PDU data may contain four additional information elements resulting in the GIE buffer 205 containing entries for ten information elements (e.g., six information elements identified with the first PDU data plus four information elements identified with the second PDU data). In addition, if an information element from a subsequent PDU data has been previously identified and listed in the GIE buffer 205 from a previous PDU data, the information element may not need a separate listing. One listing per individual information element is sufficient. To manage the memory of the GIE buffer 205 in this exemplary embodiment, the GIE library 200 may include any of the well known memory aging algorithms to remove aged data from the GIE buffer.

Another exemplary implementation of the present invention may be in the encoding and decoding of text based messages. Session Initiation Protocol (“SEP”) messages, Megaco messages, Session Description Protocol (“SDP”) messages and Multipurpose Internet Mail Extension (“MIME”) messages are examples of protocols which use text based messaging. However, once again, an application layer program may find it easier to work with data structures within the code. The present invention may be implemented in an encode/decode library (“EDL”) to convert the text based messages to the data structures and vice versa. The basic operation of the EDL is the same as the GIE library described above, except that the conversion is performed on a text based message rather than the structure of an information element.

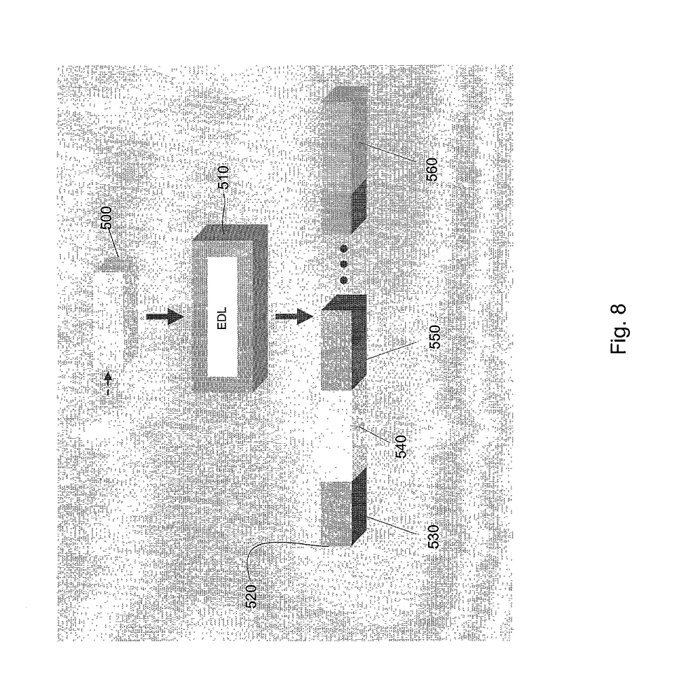

FIG. 8 shows an exemplary text message 500 being converted into a data structure 520 by the EDL 510. Similar to the above described PDU data, the raw text message 500 is received from the system. The text message 500 may be stored in a buffer when received at the particular hardware device implementing the present invention. The EDL 510 may contain functions which convert the text message 500 into a data structure 520. Those of skill in the art will understand that the described data structure 520 is only exemplary. A variety of functions may be employed by the EDL 510 to convert the text message 500 into any type of data structure which may be useful for the application programs.

In this example, the EDL 510 initiates a series of functions which decode the text message into the data structure 520. The data structure 520 contains a MSG_INFO_STRUCT header 530, a text message buffer 540, a MSG_STRUCT structure 550 and a free region 560. Each of these portions of the data structure 520 will be described in greater detail below. Those of skill in the art are familiar with the various manners of parsing a text message. Similar to the decoding described above, in order to save processing resources, the decoding of the text message 500 may occur when an application program needs the information contained in the text message 500. If an application program does not need the information, the processor resources do not need to be used to decode the text message 500. The text message 500 may be received by the system at the physical layer and may be passed up through one or more of the networking layers and used by those layers in the text format for the hardware device to accomplish the desired result. The application layer programs on the hardware device may have no need to access information contained in the text messages passed to the hardware device. The processing power of the hardware device does not need to be employed to decode these text messages which are not needed in data structure form. In addition, once the decoding has occurred, the decode message may be stored in a buffer to be used again so that the same message does not need to be decoded more than once for the system. Those of skill in the art will understand that there may be instances where lower level network layer modules (i.e., lower than the application layer) may also desire to see the information contained in the text message 500 in a data structure format rather than in the text format. The present invention may also be employed to convert messages for lower level layer modules.

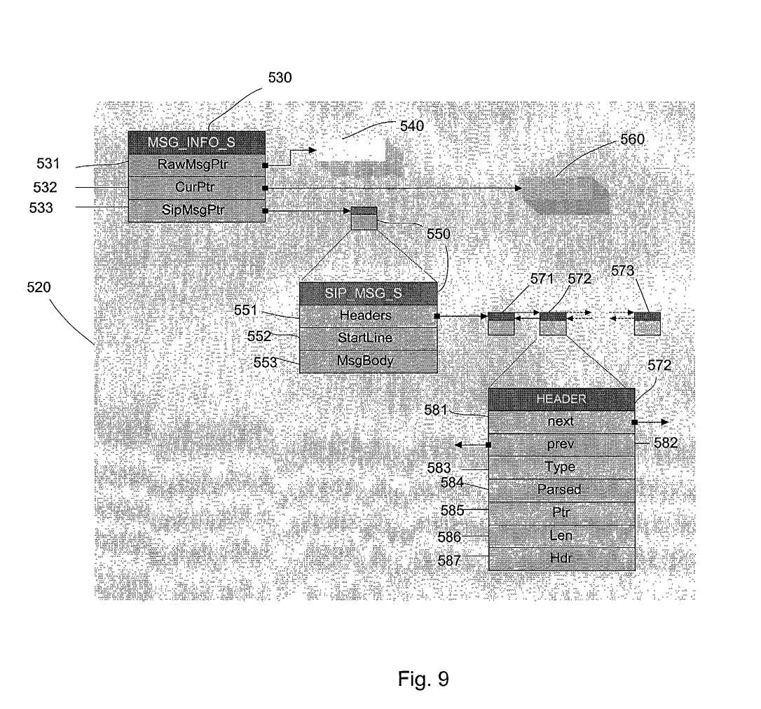

FIG. 9 shows details of an exemplary data structure 520 decoded from a text message 500. The MSG_INFO_STRUCT header 530 may include a series of pointers that point to various information contained in the text message 500. Since it is common for a text message to not include any upper limit in their size, it may not be possible to use a statically determined declaration. This may result in the use of dynamically allocated memory and pointers to the memory locations. The pointers in the MSG_INFO_STRUCT header 530 may include a RawMsgPtr 531 which points to the memory location for the buffer 540 containing the original text based message 500. It may also contain a CurPtr 532 which points to the start of the free region 560 within the memory which may be used to store additional data structures. Finally, it may contain a MsgPtr 532 pointing to the actual data structure (MSG_STRUCT structure 550) for the decoded text message 500.

The MSG_STRUCT structure 550 contains a pointer 551 to a list of the headers which may be included in the text message 500. The headers (and other fields) may occur multiple times within a text message 500 and the data structure 520 is able to process such multiple occurrences. One manner that this processing may be handled is through the implementation of a linked list which allows dynamic growth of the list of headers and the easy addition and deletion of elements within any particular header. In this example, the linked list contains three headers 571-573. Exemplary elements that may be included within a header are illustrated for header 572 and may include a pointer 581 to the next header in the linked list, a pointer 582 to the previous header in the linked list, the header type 583, a flag 584 indicating whether the header is parsed, a pointer 585 to the raw header, a value 586 for the length of the raw header and a pointer 587 to the decoded header. Those of skill in the art will understand that the preceding list of elements in a header is only exemplary and a data structure may contain more or less elements.

The MSG_STRUCT structure 550 may also contain a pointer 552 to the starting line of the message and a pointer 553 to the body of the message. The data structure 520 may be stored in the same buffer as the original text message 500 in order that the protocol and the application do not repeat the same decoding. For example, each application program may contain the functions that are included in the EDL 510. However, if two applications (or another level of the protocol stack) needed the same information from a text message 500, both the applications would need to perform the same decoding on the same text message 500. This would result inefficiencies since the processor may be carrying out the same operation multiple times.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
a first module receiving data in a first format; and
a library module building a structure in a buffer containing a plurality of data elements in the first format and creating entries corresponding to each of the plurality of data elements, each entry including a first pointer to the corresponding data element in the structure, wherein, when the first module requests a first one of the plurality of data elements, the library module reformats the first one of the data elements into a second format, stores the reformatted first one of the data elements and creates a second pointer from the corresponding entry to the reformatted first one of the data elements, the first module retrieving the reformatted first one of the data elements using the second pointer from the corresponding entry.

2. The system according to claim 1, wherein the library module, when the first module requests a second one of the plurality of data elements, the library module reformats the second one of the data elements into the second format, stores the reformatted second one of the data elements and creates a second pointer from the corresponding entry to the reformatted second one of the data elements, the first module retrieving the reformatted second one of the data elements using the second pointer from the corresponding entry.

3. The system according to claim 1, further comprising:
a second module requesting the first one of the data elements in the second format from the library module and retrieving the reformatted first one of the data elements using the second pointer from the corresponding entry.

4. The system according to claim 3, wherein the library module, when the second module requests a second one of the plurality of data elements, the library module reformats the second one of the data elements into the second format, stores the reformatted second one of the data elements and creates a second pointer from the corresponding entry to the reformatted second one of the data elements, the second module retrieving the reformatted second one of the data elements using the second pointer from the corresponding entry.

5. The system according to claim 1, wherein the first format is a bit format.

6. The system according to claim 1, wherein the first format is a text message format.

7. The system according to claim 1, wherein the second format is a C structure format.

8. The system according to claim 1, wherein the plurality of data elements are information elements.

9. The system according to claim 1, wherein the library module parses the data to build the structure.

10. The system according to claim 3, wherein the second module is an application layer module.

11. The system according to claim 1, wherein the first module is an application layer module which generates data in the first format.

12. A method, comprising the steps of:
receiving data in a first format;
building a structure from the data in a buffer containing a plurality of data elements in a first format;
creating entries corresponding to each of the data elements in the buffer, each entry including a first pointer to the corresponding data element in the structure;
reformatting a first one of the data elements from the first format into a second format;
storing the reformatted first one of the data elements in the buffer; and
adding a second pointer from the corresponding entry to the reformatted first one of the data elements.

13. The method according to claim 12, further comprising the step of:
retrieving the reformatted first one of the data elements using the second pointer from the entry.

14. The method according to claim 12, further comprising the step of:
requesting the data element in the second format, wherein the reformatting, storing and adding steps are performed after the requesting step.

15. The method according to claim 12, further comprising the steps of:
reformatting a second one of the data elements from the first format into a second format;
storing the reformatted second one of the data elements in the buffer; and
adding a second pointer from the corresponding entry to the reformatted second one of the data elements.

16. The method according to claim 12, wherein building the structure includes the substep of:
parsing the data in the first format.

17. A library module, comprising:
a first element configured to build a structure containing a plurality of data elements in a first format and selectively reformatting the data elements into a second format based on a request from network modules; and
a buffer storing the data elements in the first format and the second format, the buffer further including entries corresponding to each of the data elements, a first pointer from each entry to the corresponding data element in the first format and a second pointer from each entry to the corresponding data element in the second format.

18. The library module according to claim 17, wherein the entries, the first pointer and the second pointer are created by the first element.
